(19) United States
(12) Patent Application Publication
(10) Pub. No.: US 2017/0278033 A1
(43) Pub. Date: Sep. 28, 2017

(54) DETERMINING COMPLEMENTARITY

(71) Applicant: Geert Arthur Edith Van Wonterghem, Zwijndrecht (BE)

(72) Inventor: Geert Arthur Edith Van Wonterghem, Zwijndrecht (BE)

(21) Appl. No.: 15/506,341

(22) PCT Filed: Aug. 27, 2015
(86) PCT No.: PCT/BE2015/000039

§ 371 Date: Feb. 24, 2017

(30) Foreign Application Priority Data
Aug. 29, 2014 (BE) 2014/0675

(51) Int. Cl. G06Q 10/06; G06F 17/30

(52) U.S. Cl. CPC G06Q 10/0637; G06F 17/3007; G06F 17/30011

(57) ABSTRACT

Method for determining an indication of complementarity between two entities, wherein a word database is compiled for each entity in which word clusters related to the entity are entered, wherein at least two areas are distinguished in the database for each entity, these being:—areas of activity of the entity; and—areas of capacity of the entity, wherein an algorithm is used to calculate a semantic similarity between the areas of activity and between the areas of capacity of the two entities; wherein the method produces a positive indication of complementarity when the first and second semantic similarity lie respectively above and below a threshold value.

The present invention relates to a method for determining an indication of complementarity between two entities.

Complementarity between two entities is an indication of how complementary these entities are. In other words, it is an indication of the degree to which two entities match each other in a predetermined context. Complementarity indicates here that the two entities supplement each other so as to form a whole. The principles hereof can be applied in all manner of fields. Complementarity can thus be sought between two persons in order to assess the chance of a successful romantic relationship, for instance in the case of dating websites. This principle can also be applied to select interesting articles, publications, books and so on for a person, wherein the one entity is the person and the other entity the article, publication, book and so on, and wherein the complementarity between these entities determines the extent to which the article/publication/book and so on can be of added value to the person. In the context of the invention a method for determining an indication of complementarity is optimized for collaboration in the context of innovation, also referred to below as an innovation project. The complementarity between persons, between companies and between a person and a company is assessed here in order to maximize the chance of success of an innovation project.

In order to bring an innovation project to a successful conclusion there has to be a good match between collaborating persons/companies. This is normally assessed by an innovation manager, i.e. an intermediary, who often knows the persons/companies and then brings them together. In practice this is typically based on a personal opinion of the innovation manager or intermediary.

A recent trend has been the organization of innovation days. Persons/companies are brought together here on a large scale and such innovation days are visited by many people and companies. During such innovation days contacts are made between different people and companies in order to start innovation projects. In practice these contacts are made randomly and haphazardly on such innovation days. Contacts can alternatively be managed by a so-called innovation manager on such innovation days.

It is an object of the invention to provide a method with which complementarity between two entities can be assessed in a structured manner so that specifically focused contacts can be made on the basis thereof.

The invention provides for this purpose a method for determining an indication of complementarity between two entities, wherein a word database is compiled for each entity in which word clusters related to the entity are entered, wherein at least two areas are distinguished in the database for each entity, these being:

Area of activity of the entity; and

Area of capacity of the entity,

wherein a predetermined algorithm is used to calculate a first semantic similarity between the areas of activity of the two entities and to calculate a second semantic similarity between the capacities of the two entities; and wherein a first threshold value is determined for the similarity between areas of activity and a second threshold value for the similarity between the areas of capacity, wherein the method produces a positive indication of complementarity when the first semantic similarity lies above the first threshold value and the second semantic similarity lies below the second threshold value.

The invention is based on the insight that an innovation project has a maximum chance of success when entities are engaged in similar activities but do not have the same capacities. Entering the areas of activity and areas of capacity in a database for each entity enables a computer system to calculate a semantic similarity between the areas of activity of the entities and between the areas of capacity of the entities in automatic manner. The invention is based here on the insight that a great similarity in areas of capacity indicates that entities are competitors. Little similarity in areas of activity indicates that entities have few common interests. Such factors are an obstacle to a successful innovation project. In the invention a first threshold value and a second threshold value are therefore determined and the areas of activity must have a semantic similarity above the first threshold value, while the areas of capacity have a semantic similarity below the second threshold value. This results in a positive indication of complementarity at the moment that entities are engaging in similar activities and thereby have common interests while not being competitors because they have differing capacities. Application of the method according to the invention is possible with a computer in simple manner and on large scale such that an organized innovation day can be managed on the basis of complementarity indications calculated according to the invention. The efficiency of meetings between persons/companies on such days is hereby considerably improved.

At least one related document is preferably provided for each entity, wherein the word database is compiled on the basis of at least one related document. Examples of related documents, when the entity is a person, are social media profile of the person, the website of the company or organization for which the person works, publications authored by the person, patents of which the person is inventor and/or applicant. The word database can be compiled on the basis of such documents by filtering words from these documents which relate to the area of activity and to the area of capacity of the person. When the entity is a company, examples of related documents are the website of the company, the publications by the company and the patents of which the company is applicant. The activities and the capacities of the entity can be distinguished by basing the database on such documents related to the entity.

The word database is preferably compiled by scanning the related documents and subdividing the words therefrom into predetermined categories, of which the area of activity category and the area of capacity category form part. The categories are more preferably defined in reference databases comprising collections of reference words to which the words from the related documents are compared. The reference databases comprise a list of words for each area. This means that there is a list of words which describe areas of activity and a list of words which describe areas of capacity. The database can be compiled in technically simple manner by comparing this list of words to the words from the related documents.

A degree of complementarity is preferably further calculated between the two entities on the basis of a difference between the first threshold value and the first semantic similarity on the one hand and the difference between the second threshold value and the second semantic similarity on the other, which differences are multiplied by respectively a first and a second predetermined weighting factor, wherein the first predetermined weighting factor is positive and wherein the second predetermined weighting factor is negative. Calculating a degree of complementarity makes it possible to assign a value to the estimated chance of success of an innovation project with the two entities. Assigning a value further allows a comparison to be made between complementarities of entities in a group of more than two entities. Such a comparison further allows an optimal subdivision to be made in a group of more than two entities, wherein groups of entities are formed which have a high or at least acceptable degree of complementarity.

At least two areas in the database preferably comprise for each entity a further area with at least one of personal information, company information and dynamic information. By further expanding the database with areas comprising personal information, company information and dynamic information in addition to areas of activity and areas of capacity of the entity it is possible to further make the complementarity between the two entities dependent on this additional information. This can further increase the chance of a successful innovation project.

The entity is preferably a person. The personal information more preferably comprises at least one of the following areas:

Area of job level;

Personality characteristic (i.e. one is a thinker and another a doer);

Area of culture;

and wherein complementarity is further made dependent on a degree of similarity between at least one of the areas of personal information. Practical tests in respect of innovation collaborations have shown that persons with the same or similar job level are better able to communicate with each other. Persons with a similar cultural background can also communicate better because there is more common ground on a personal level. Examples of culture are hobbies, level of education, home background, ambition, creativity, degree of ‘hipness’ and so on. The chance of a successful innovation project is also increased appreciably when the persons can communicate better with each other.

The company information preferably comprises at least one of the following areas:

Area of size;

Area of culture;

Area of geographical location;

Area of innovativeness;

Financial area;

and wherein complementarity is further made dependent on a similarity between at least one of the areas of company information. The comparison of company information is based on the insight that companies of the same or similar size or greatly differing sizes can successfully complete an innovation project more easily than companies of differing but not extremely differing size. Companies with a similar culture, i.e. corporate structure, management structure, degree of innovativeness and so on, can thus also collaborate more easily. Geographic location increases the practical possibilities for collaboration. A corresponding innovation policy and/or similar or substantially similar financial resources also further increase the chance of success of an innovation project.

The dynamic information preferably comprises at least one of the following areas:

Area of diversity;

Area of preference;

Area of physical location;

and wherein complementarity is further made dependent on the dynamic information areas. Dynamic information is mainly of added value when a large group of entities has to be coordinated in small groups over time, for instance a networking event. During such a networking event it is advantageous to allow an entity to network with a maximum of diverse other entities. This can be tracked in the area of diversity. Preferences of the entity can be tracked in the area of preference, and the preferences can be taken into account when determining a degree of complementarity. It can be useful particularly in the case of large networking events to include physical location of a person in the algorithm. In order to move quickly from one table to another the distance can be minimized in order to match the large group of people efficiently.

The complementarity is preferably further made dependent on predetermined preferences. An entity can itself hereby provide direction in an innovation project by indicating the characteristics and/or additional capacities (such as salespeople, technical or, conversely, company profiles) which are desired.

The complementarity is further preferably provided in order to determine and take into account previous meetings between entities. It is thus possible to avoid entities which have just completed an innovation project being matched up again by a computer performing the method according to the invention.

The invention will now be further described on the basis of an exemplary embodiment shown in the drawing.

In the drawing:

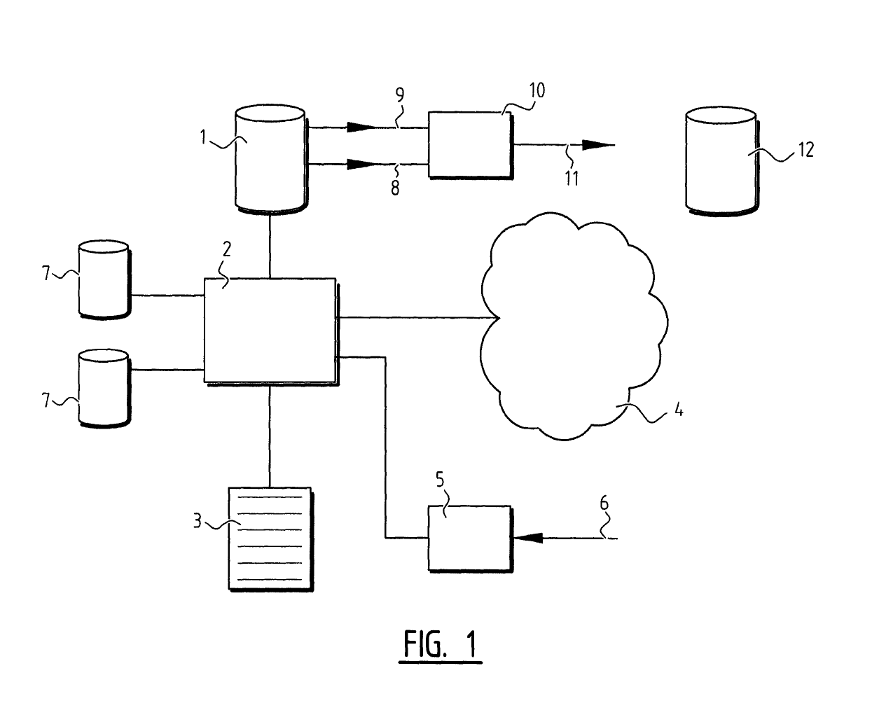

FIG. 1 shows a diagram of modules which allow the method according to an embodiment of the invention to be performed.

The same or similar elements are designated in the drawing with the same reference numerals.

The present invention has for its object to approach in a technical manner the matching of different entities in the context of innovation projects. In the context of this description entity is defined in the first instance as a source of knowledge. The source of knowledge preferably has at least some relevance here in at least one previous, current or future innovation project so as to add relevant knowledge about at least one aspect of the innovation project. Entity is preferably defined as a person or company which can be a party in an innovation project. It will be apparent that a person and a company also form a source of knowledge. A publication, article or book does fall within the broad definition of entity, but no longer falls within the preferred definition of entity. Unless defined otherwise, entity will be understood in its broad definition. It will however be apparent to the skilled person that the whole description can likewise be read with the narrow definition of the word entity.

An important aspect of the method according to the invention is the compiling of a word database 1. Entered in this word database 1 for each entity are word clusters related to the entity. A distinction is made here between word clusters relating to the activities of the entity and word clusters relating to the capacities of the entity. These words can be assigned dynamically as activity or capacity, depending on the context of the event and an algorithm which determines this per event. In the case of for instance an internal event at a company which produces shoes, the term “shoe” is an activity and not a capacity. It will be apparent to the skilled person that a word database 1 can be realized technically in different ways. According to a first simple method, a table can be created wherein each entity forms one row and wherein each column comprises a predetermined word cluster which describes predetermined characteristics of the entity. The first column can thus comprise the name of the entity, the second column can comprise the activities of the entity, the third column can comprise the capacity of the entity, the fourth column can comprise the corporate culture of the entity, and so on. A second method for technical realization of word database 1 is by collecting for instance text files, wherein each text file is related to one entity and wherein each text file has a structure such that a distinction can be made between different areas, such as area of capacity and area of activity. According to a further embodiment, the word database is formed as a multi-dimensional coordinate in a ‘concept universe’ which is assigned to each entity. Another possible approach is for activities to be defined on the basis of the NACEBEL code of the company.

The method according to the invention comprises on the one hand aspects relating to compiling of word database 1 and on the other aspects for use of word database 1. In this description the compiling of word database 1 will be described first, and the use of word database 1 will then be described.

Word database 1 is compiled by means of a processor 2 which executes predetermined algorithms on the basis of documents related to the entities of word database 1. The skilled person will be able to construct the algorithms on the basis of the description following below in order to achieve the described effects. The description will therefore be limited to describing the effects and objectives of processor 2 and the algorithms running thereon.

Processor 2 can be provided with a list 3 in which entities are identified. The list can for instance be a list of names or a list of companies. The list can be entered manually and then processed by processor 2. List 3 can alternatively be generated by the processor, for instance on the basis of social media. A plurality of users (persons or companies) are connected directly or indirectly to each other on social media, and these connections can be used to compile list 3.

On the basis of list 3 processor 2 will consider at least one related document for each entity. Processor 2 can for instance be connected to internet 4 for this purpose. Processor 2 can be provided here for the purpose of scanning predetermined databases via the internet and filtering information therefrom relating to the entity so as to thus be able to consider one or more related documents. Processor 2 can for instance be provided for the purpose of searching predetermined social media databases in order to collect information about the entity. Processor 2 can further be provided for the purpose of searching predetermined patent databases and/or publication databases in order to find documents to which the entity, author, inventor, applicant or other is related. These documents can also be taken into consideration.

When selecting documents, popularity (for instance number of followers on social media) and authority in the relevant field of the author of each document can be included in the weighting given to the document. This weighting can further be taken into consideration when determining a similarity between entities. Other parameters which can be added are ‘degree of lightheartedness’ and desired length of the documents, as well as the language and recentness of the documents. Semantic similarity to a predetermined concept can further be of importance, for instance in order to obtain mainly documents from entrepreneurs instead of academics.

A manual input 5 can further be provided for manual input 6 of documents related to an entity. These documents can stand alone or can be an addition to documents and/or information collected by processor 2 from the internet 4 on the basis of predetermined search algorithms

When one or more related documents have been collected for an entity, processor 2 is provided for the purpose of scanning these related documents in order to filter therefrom words and/or word clusters relating to a predetermined area. These filtered words are then stored in word database 1 in order to thus compile word database 1. The different areas which can be filtered from the related documents by processor 2 can be determined beforehand. A predetermined algorithm can be defined for each area. A non-exhaustive series of examples of areas which may be of interest for inclusion in word database 1 is given below by way of illustration.

area of activity

area of capacity

area of job level

area of culture

area of size

area of geographical location

area of personality characteristics

area of innovativeness

financial area

area of diversity

area of preference

Filtering of the predetermined areas from the related documents by processor 2 can be technically implemented in different ways. According to a first method, an algorithm can be provided which relates a predetermined segment from a pre-known database, for instance a social media database, to a predetermined area. A clustering of words can in this way still be obtained by processor 2 without substantive knowledge or understanding of the words. According to an alternative method, which is recommended, reference databases 7 are connected to processor 2, wherein each reference database 7 comprises a list of words which describes one of the areas. A list of words can thus be provided which describes possible activities of an entity. A list can also be provided which describes possible capacities of an entity, and so on. During scanning of the documents the words from the documents are compared to the words from reference databases 7. When a match is found in a related document, this matching word or word cluster is stored in the word database. Reference databases 7 can be created manually or semi-automatically here, wherein a manual start is made and wherein an algorithm is provided for the purpose of collecting synonyms and word clusters with the same meaning, for instance on the basis of a dictionary.

When word database 1 is compiled on the basis of the related documents, a collection of words is obtained for each entity, this collection of words being divided into a plurality of areas. An example of a word database 1 is shown below, wherein each column comprises the words related to one entity and wherein each row describes a predetermined area. It will be apparent here that a row can comprise a plurality of words and/or word clusters, as also shown in the example below.

| | Business 1 | Business 2 | Business 3 | Business 4 |
|---|---|---|---|---|
| area of activity | Entertainment | Sports | Sports | Sports |
| | Sports | Running | Tennis | Running |
| | Running | Clothing | Clothing | Mobile apps |
| | Tennis | | | |
| area of capacity | Shoes | Shirts | T-shirt | Tracker |
| | Soles | Shoes | Polo | GPS |
| | Leather | | Fabrics | |
| | | | Socks | |

In the above example the combination of company 1 and company 4 will obtain a positive indication of complementarity because they have two activity words which are the same and no capacity words which are the same. Because company 1 and company 4 do not have the same capacities, the chance of them becoming competitors during or after an innovation project will be small. Because company 1 and company 4 have matching activity words however, they are active in the same market, which increases the chance of a successful innovation project.

Although company 1 and company 2 have two areas of activity which are the same, they also have a high chance of becoming competitors since they have the same capacities, i.e. they both make shoes. The indication of complementarity between company 1 and company 2 is therefore less high.

It will be apparent to the skilled person that the above example is a greatly simplified example and that several rows could be added, for instance describing the size of the company, describing the financial resources of a company, describing the corporate culture, describing the location of the company and so on. The degree of complementarity can be further refined by also making a comparison between these further areas.

In respect of complementarity between two entities it is possible to give an indication of complementarity wherein an indication is a Boolean and thereby indicates whether two entities are complementary or not. A degree of complementarity can alternatively be calculated by means of a mathematical formula. In calculating a degree of complementarity a weighting factor will be predefined for each area, and the semantic similarity will preferably be considered in relation to a predetermined threshold value.

In respect of the above example a positive indication of complementarity could be given when the number of similarities within the area of activity is greater than two (first threshold value =2) and the similarity in the areas of capacity is less than zero (second threshold value=0). According to the table above company 1 and company 2 would receive a negative indication of complementarity because they have a similar capacity. Company 1 and company 4 would have a positive degree of complementarity because the condition of a minimum of two similarities in area of activity and of a maximum of zero similarities in area of capacity have been satisfied. A degree of complementarity can alternatively also be calculated according to the formula below.

G=degree of complementarity

Idem^{act}=number of semantic similarities between respective areas of activity of two entities

Drem^{act}=the first threshold value

Fact^{act}=the first weighting factor

Idem^{act}=number of semantic similarities between respective areas of capacity of two entities

Drem^{cap}=the second threshold value

Fact^{cap}=the second weighting factor; this second weighting factor is preferably negative so that an increase in the number of semantic similarities has a negative effect on the degree of complementarity. This principle of negative weighting factor can be applied anywhere where an increase in semantic similarity lowers the chances of a successful innovation project.

Idem^{areaX}=number of semantic similarities between respective X^{th} area of two entities

Drem^{areaX}=the X^{th} threshold value

Fact^{areaX}=the X^{th} weighting factor of a predetermined area X

G=(Idem^{act}−Drem^{act})×fact^{act}+(Idem^{cap}−Drem^{cap})×fact^{cap}+(Idem^{areaX}−Drem^{areaX})×fact ^{areaX} Formula:

Complementarity can further be used for instance to match salespeople to buyers. Salespeople have a greater chance here of selling something to a buyer if they are active in a similar field (for instance cars) and are not too far apart and not too close together in the value chain. A paint manufacturer and car assembly location are for instance possible, but not a paint manufacturer and car sales location.

In another example several areas of activity are filtered from the related documents, and areas of capacity are entered, for instance via a form. At a networking event for start-ups the participant can thus enter via a form that he/she is 1-investor, 2-possible co-founder or 3-possible early employee of a start-up. The participant can further indicate which of the above he/she is looking for. This can be added as extra input to the algorithm for determining the degree of complementarity.

The skilled person will appreciate that this is only a simplified example of a formula and that this formula can in practice be provided with further conditions. The skilled person will further appreciate that the above described steps of the method can be performed by a computer program. Several embodiments are also intended here to cover storage means for computer programs, for instance digital storage media readable by a machine or computer, and encoded machine-executable or computer-executable programs or instructions, wherein the instructions execute some or all of the above described steps of the method. The program storage device can for instance be a digital memory, magnetic storage medium such as a magnetic disk and magnetic tapes, a hard drive or optically readable digital storage medium. The above described embodiments are also intended to comprise computers programmed to execute the above stated steps of the method.

The description and the figures serve only to illustrate the principles of the invention. It will therefore be appreciated that a skilled person can deviate from the different setups which may or may not have been explicitly shown and described above and which comprise the principles of the invention. All examples described herein are further intended solely for the purpose of illustrating the invention and aiding the reader in properly understanding the principles of the invention. The examples will not be limitative here to the scope of protection. All statements describing principles, aspects and embodiments of the invention and specific examples thereof are here also understood to comprise equivalents thereof. The scope of protection of the present invention will therefore be defined solely by the following claims.

1. A method for determining an indication of complementarity between two entities, herein a word database is compiled for each entity in which word dusters related to the entity are entered, wherein at least two areas are distinguished in the database for each entity,these being:
areas of activity of the entity; and
areas of capacity of the entity,
wherein a predetermined algorithm is used to calculate a first semantic similarity between the areas of activity of the two entities and to calculate a second semantic similarity between the areas of capacity of the two entities; and wherein a first threshold value is determined for the similarity between the areas of activity and a second threshold value for the similarity between the areas of capacity, and
wherein the method produces a positive indication of complementarity when the first semantic similarity lies above the first threshold value and the second semantic similarity lies below the second threshold value.

2. The method as claimed in claim 1, wherein at least one related document is provided for each entity, wherein the word database is compiled on the basis of the at least one related document.

3. The method as claimed in claim 2, herein the word database is compiled by scanning the at least one related document and subdividing the words therefrom into predetermined categories, of which the areas of activity category and the areas of capacity category form part.

4. The method as claimed in claim 3, wherein the categories are defined in reference databases comprising collections of reference words to which the words from the at least one related document are compared.

5. The method as claimed claim 1, wherein a degree of complementarity is further calculated between the two entities on the basis of a difference between the first threshold value and the first semantic similarity on the one hand and the difference between the second threshold value and the second semantic similarity on the other, which differences are multiplied by respectively a first and a second predetermined weighting factor, wherein the first predetermined weighting factor is positive and wherein the second predetermined weighting factor is negative.

6. The method as claimed in claim 1, wherein the at least two areas in the database comprise for each entity a further area with at least one of personal information, company information and dynamic information.

7. The method as claimed in claim 6, herein the entity is a person.

8. The method as claimed in claim 7, wherein the personal information comprises at least one of the following areas:
area of job level;
area of culture; and
area of personality characteristics; and
wherein complementarity is further made dependent on a similarity between at least one of the areas of personal information.

9. The method as claimed in claim 6, wherein the company information comprises at least one of the following areas:
area of size;
area of culture;
area of geographical location;
area of innovativeness; and
financial area; and
wherein complementarity is further made dependent on a similarity between at least one of the areas of company information.

10. The method as claimed in claim 6, wherein the dynamic information comprises at least one of the following areas:
area of diversity;
area of preference; and
wherein complementarity is further made dependent on the dynamic information areas.

11. The method as claimed in claim 1, wherein the complementarity is further made dependent on predetermined preferences.

12. The method as claimed in claim 1, wherein the complementarity is further provided in order to determine and take into account previous meetings between entities.
